(19) United States
(12) Patent Application Publication
(10) Pub. No.: US 2022/0065372 A1
(43) Pub. Date: Mar. 3, 2022

(54) MIXED FEMALE CONNECTOR OR PORT

(71) Applicant: AD-VENTA, Bourg-de-Péage (FR)

(72) Inventors: Jean-Luc MUSSOT, Loriol sur Drome (FR); Olivier LABROT, Portes-les-Valence (FR)

(21) Appl. No.: 17/521,745

(22) Filed: Nov. 8, 2021

Related U.S. Application Data
(63) Continuation of application No. 16/637,259, filed on Feb. 6, 2020.

(30) Foreign Application Priority Data
Mar. 27, 2017 (FR) 17/00327

(51) Int. Cl. F16L 15/00; F16L 15/04; F16L 41/10

(52) U.S. Cl. CPC F16L 15/008; F16L 41/10; F16L 15/04

(57) ABSTRACT

The disclosure relates to a connector that includes at least a female port, wherein the female port is configured for receiving, in a gas tight manner, alternatively, two male connectors of two different given types. The two male connectors can have the same thread pitch and diameter. The female port can include a female thread suitable for respectively receiving threads of the two male connectors. The female port can include two first parts of two different sealing devices, one having a seal and the other being metal-on-metal, each compatible with one of the male connectors, and each of a given type different to the other.

### CROSS REFERENCE TO RELATED APPLICATIONS

This application claims priority to and is a continuation patent application of U.S. patent application Ser. No. 16/637,259 filed on Feb. 6, 2020, which is a national phase filing under 35 C.F.R. § 371 of and claims priority to PCT Patent Application No. PCT/FR2018/000077, filed on Mar. 26, 2018, which claims the priority benefit under 35 U.S.C. § 119 of French Patent Application No. 17/00327, filed on Mar. 27, 2017, the contents of each of which are hereby incorporated in their entireties by reference.

### BACKGROUND

The presently disclosed subject matter relates to a female connector (or rather a port, as explained below) suitable for receiving male pipe connectors (or ports), in which a fluid flows, to form a coupling or establish a connection.

The technical field of some embodiments is the manufacturing of such female connectors (ports) to which male connectors are connected essentially by screwing, and one of the main applications is in circuits conveying a gas, such as hydrogen, particularly at high pressure.

Different types of coupling are thus known, consisting of connectors suitable for various pressure levels of the fluid that flows in the pipes connected to these connectors, and the sealing of which (applied during the assembly of the connectors to each other, that is, when the male connector is connected to the female connector of the coupling) can be different depending precisely on the operating pressure, the required quality of the seal as a function of the fluid (in particular for hydrogen, the very small molecules of which can seep into very small orifices, which will thus generate a leak, while other heavier gases will not be able to seep into them and will not leak), and the manufacturers themselves.

Two families of connectors of those used most widely in industry can thus be mentioned, namely:

the most common connectors, in accordance with SAE J1926 (or ISO 11926-1), which will be called SAE connectors, which are more suitable for and used at medium pressures (i.e. between 150 and 500 bar generally) and the sealing of which, which can be described as external, is provided by an O-ring: the male connector (or port) is in this case provided with such an O-ring, which is firmly clamped (on connection by screwing this male connector into the female connector of the coupling) between an angular sealing surface or bearing surface of the external orifice of the female connector (or port), the groove situated at the base of the thread of the male connector (or port) (i.e. in the opposite direction to the distal end of this thread) and in which the O-ring is placed, and the shoulder (with or without a reinforcing ring or retaining washer) situated on the other side of the groove relative to the thread of the male connector,

cone and thread connectors, called MP connectors (including for example those in the IPT series sold by Swagelok: see pages 902 and 903 of its 2016 catalogue reference MS-02-472), which are essentially used in the field of high pressures (i.e. above 500 bar and up to around 4,000 bar) and when the temperature of the fluid that flows in them is high (such as above 100° C.), and the sealing of which, which can be described as internal, is provided by cone-on-cone direct metal contact and pressure: the distal end of the male connector (which at Swagelok is in fact the distal end of the pipe to be connected, which passes through the male connector and is locked in it by various intermediate parts) beyond the thread thereof is conical and comes into direct contact with a corresponding cone made in the bottom of the female connector before the thread thereof (i.e. in the opposite direction to the end of this thread situated on the side of the intake orifice of this female connector) into which the thread of the male connector is screwed.

Thus, in all or most of the current screwed connectors like those mentioned above, ensuring sealing for a given pressure range and depending on the gas flowing in them, a female connector of the same type as the male connector that is to be connected by screwing must or should be available, not only in terms of the thread (which does not however pose a problem, as manufacturers use the same standard diameters and thread pitches) but also in terms of the sealing device, which complicates the compatibility of an appliance or component having a given type of female connector, as only a given male connector can then be connected to it, of course of the same diameter, but also with the same type of sealing.

This is troublesome when a supplier wishes to offer an appliance (such as an expansion valve, a storage tank, etc.) or a component (such as a check valve, a gate, etc.) of a gas circuit to various customers that use different types of connector, such as the two main types mentioned above: in this case, the supplier must or should either also offer its appliance or component in two versions that each correspond to a type of sealing and therefore a type of connector (which complicates the management of these products and increases both costs and the risk of delivery errors), or make two parallel female connector orifices on the same appliance or component, each corresponding to a type of sealing and therefore a type of male connector (which further increases the cost and the footprint of each product), or supply a specific adapter for the orifice of the female connector of the chosen type of sealing so that a customer using the other type of sealing and therefore connector can connect to it (which may require an additional component, and also increases the cost, footprint and risk of leaks).

### SUMMARY

Some embodiments therefore addresses the problem of enabling the compatibility of a second type of male connector (or port) to be fastened to the same female connector (which must or should be considered to be a single female port as explained below) also compatible with a first type of male connector (or port), the two types of male connector (or port) each having a different sealing device from the other, in order to meet different operating conditions, but that must or should thus be compatible with this same female connector or port.

In the description below, the term “port” will be used instead of “connector”, at least in relation to the female part, to avoid confusion with the fact that a single female connector (in the broad sense), which can have several different types of port, could thus receive several different male connectors in its different ports (and therefore simultaneously), as can be found in the related art such as patent application US2014/0196524. Conversely, in relation to the male part the term connector or port can be used equally as it has no impact on the interpretation of some embodiments, which relates mainly to the female part.

One solution to the problem addressed is of course an adapter as used currently, but according to some embodiments an improved solution is a female connector or therefore rather a “port” (considered in this description, and as explained above, as being a single port), suitable for receiving in a tightness manner and being sealably connected to a first male connector (or port) of a given type and for enabling a flow of gas through the connection thus made, and such that it includes:

a first part of a first sealing device compatible with a second part of this first sealing device carried by the first male connector, which first part of this first sealing device being a bearing surface against which is squeezed, when the first male connector is screwed into the female port, the second part of this first sealing device, which is a seal that can be housed in a groove situated at the proximal end of the thread of this first male connector,

at least another first part of another second sealing device compatible with another second part of this other second sealing device,

and such that according to some embodiments, this second first part of this second sealing device is a female metal geometric shape made at the bottom of the thread of the female port and suitable for receiving a compatible male metal geometric shape, situated at the distal end of another different second male connector of another given type and suitable for providing by contact against each other a metal-on-metal seal and thus also for being connected to this same female port.

According to an embodiment, the female port according to some embodiments is such that it includes a thread suitable for receiving any one of the threads of the at least two different types of first and second male connectors and having the same thread pitch and diameter compatible with the same thread of the female port.

According to an embodiment, the male metal geometric shape of the second sealing device is situated at the distal end of the other second male connector, this distal end being either that of the connector itself, or that of the pipe to be connected, which passes through and is locked in this second male connector, and through which the gas can flow. In another embodiment, this male metal geometric shape forms part of a pipe anchoring device at the distal end of this second male connector.

Thus, with the same female connector, or port, made on an appliance or a component, it is possible to alternately and/or successively connect to it at least two types of male connector, or port (of course of the same diameter), without this costing more, occupying more space, or generating an additional risk of leaks, and while thus being able to satisfy customers who wish to use different types of connector.

The result is a new female port (connector) that can be described as “mixed”, which provides a satisfactory response to the problem addressed, the advantages of which set out above prove the interest thereof, and which is unrelated to the existing female ports (or connectors) including two sealing devices (known as primary and secondary, with the aim of measuring any leaks between these two seals) and intended to receive a single male connector as described for example in patent application DE102014010090.

### BRIEF DESCRIPTION OF THE FIGURES

The description and the attached figures relate to an embodiment of a mixed female port according to some embodiments, but other embodiments are possible within the scope of the presently disclosed subject matter.

FIG. 1 is an axial cross-sectional view of an embodiment of a female port (connector) according to some embodiments into which is screwed a first male connector of a first type, taken for example as being a connector called an SAE connector.

FIG. 2 is the same axial cross-sectional view of the female port (connector) in FIG. 1 but into which is screwed another second male connector of a second type, taken for example as being a connector called an MP connector, shown diagrammatically without the details of the intermediate parts.

FIG. 3 is an axial cross-sectional view of the same single female port (connector), called a mixed female port according to some embodiments, as in FIGS. 1 and 2 without a male connector screwed into it but ready to receive as desired one or other of the male connectors in FIGS. 1 and 2.

### DETAILED DESCRIPTION OF EXEMPLARY EMBODIMENTS

According to the figures a female connector, or rather port 1 according to some embodiments, and as shown alone in FIG. 3, is suitable for sealably receiving, alternately and/or as desired:

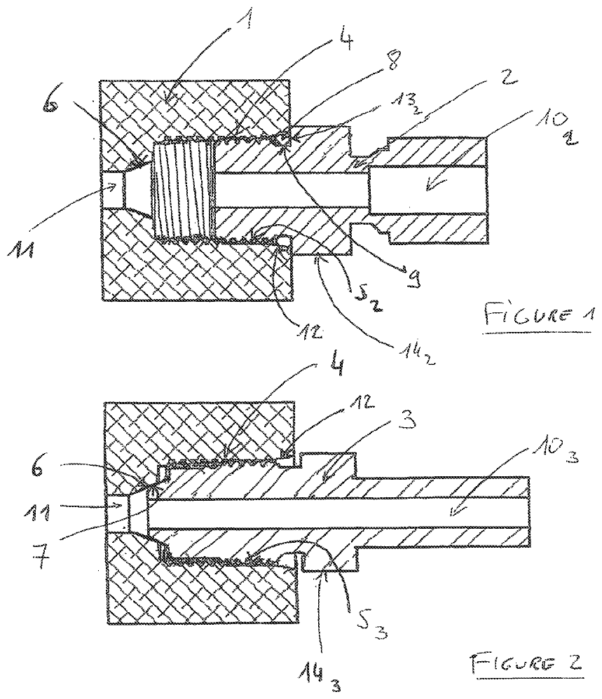

either, according to FIG. 1, a first male connector (or port) 2 of a first given type so as to enable the flow of gas through the connection made in this way, and the female port 1 including to this end a first part 12 of a sealing device compatible with a second part 8 of this sealing device borne by the male connector 2,

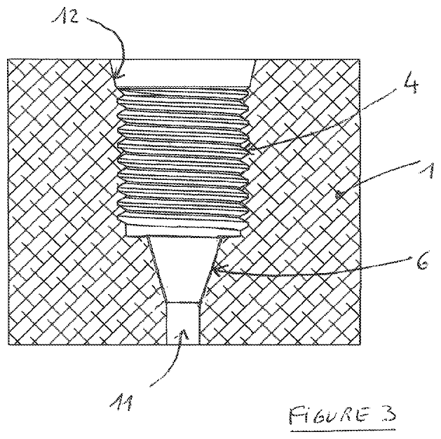

or, according to FIG. 2, a second different male connector (or port) 3 of another given type (different from the first type) and the female port 1 including to this end another first part 6 of another sealing device compatible with another second part 7 of this other sealing device borne by this second male connector 3 of another given type.

This female port 1 according to FIG. 3 includes a female thread 4 suitable for receiving any one of the threads 5₂, 5₃ of the two first and second male connectors 2, 3 respectively and having the same thread pitch and diameter in accordance with any one of the relevant recognized standards, i.e. SAE, ISO, ASTM, DIN, etc.

The first part 12 of a first sealing device is a bearing surface 12 (such as conical) against which is squeezed, when the first male connector 2, called an SAE connector, is screwed into the female port 1 according to FIG. 1, the second part of this first sealing device, which is an O-ring 8 housed here in a groove 9 situated at the proximal end of the thread 5₂ of this first male connector or port 2 (that is, situated at the base of this thread 5₂ i.e. in the opposite direction to the distal end thereof and against the shoulder 13₂ of the head 14₂ of this first male connector 2): in fact the O-ring 8 is thus firmly clamped between the sealing bearing surface 12 of the external orifice of the female part (or port) 1, the groove 9 in which the O-ring is placed, and the shoulder 13₂ (with or without a reinforcing ring or retaining washer) situated on the other side of the groove 9 relative to the thread 5₂ of this first male port (connector).

However, such sealing, which can be described as “external”, although sufficient for medium pressures, i.e. between 150 and 700 bar (or even a little higher), and with hydrogen flowing in the inner passages 10₂, 11 respectively of the two male and female connectors and ports 2, 1 screwed into each other, does not ensure satisfactory resistance to high pressures, in particular such as up to 1,000 bar and even significantly higher (such as 4,000 bar), especially with a gas such as hydrogen, and to high temperatures (above 100° C.)

The other first part 6 of the other sealing device is thus a female metal geometric shape 6 (such as shown in the figures as a conical surface, but this could also be spherical) made at the bottom of the thread 4 of the female port 1, i.e. in the opposite direction to the orifice thereof, and suitable for receiving, according to FIG. 2, a male metal geometric shape 7 (such as shown in this figure as a conical surface, but this could also be spherical) (compatible with the female metal geometric shape 6 in order to provide a metal-on-metal seal by contact), made at the distal end, i.e. situated in the opposite direction to the head 14₃, of the other different second male connector 3 or of the pipe to be connected, which passes through and is locked in this second male connector, called an MP connector.

Such sealing, which can be described as “internal”, by surface-on-surface (i.e. cone-on-cone) direct metal contact, ensures satisfactory resistance not only to high temperatures but also to high pressures, in particular above 700 or 1,000 bar (and even up to 4,000 bar), even with hydrogen flowing in the inner passages 10₃, 11 respectively of the two male and female connectors or ports 3, 1 screwed into each other.

Thus:

the first O-ring sealing device 12, 8 described above provides the seal between the female port 1 and a first male connector (or port) 2 of a first given type, such as the SAE type, suitable for being connected to this female port 1, in different operating conditions (such as up to an operating pressure with hydrogen of 500 or even 700 bar or even a little higher at most) from those for which

the second metal-on-metal sealing device 6, 7 described above provides this seal, between the same female port 1 and another second male connector (or port) 3 of a second given type, such as the MP type, suitable for being connected to this same female port 1, which can in this case be described as “mixed”, especially above an operating pressure of 700 bar up to at least 1,000 bar and higher, even with hydrogen.

The different operating conditions between the first 12, 8 and second 6, 7 sealing devices are those determined by at least one condition linked at least to pressure (as stated above), but also to temperature, chemical attack and vibrations (or other criteria): the project manager, customer or installer can thus choose between one type of male connector or another depending on the operating conditions in question while keeping the same female port 1.

The users of appliances or components provided with such mixed female ports 1 according to some embodiments, and as shown alone in FIG. 3, can thus decide at any time to connect to it the male connector (or port) of their choosing, corresponding to one of the sealing devices compatible with the female port according to some embodiments, without any need for an adapter or having had to order a specific appliance or component provided with female ports according to a single type of sealing device corresponding to their choice (which they can then no longer change), as is currently the case.

What is claimed is:

1. A connector, comprising:
a female port that includes:
a bearing surface that constitutes a first part of a first sealing device;
a threaded inner surface that includes a thread, and the thread having a bottom;
a bottom end surface that is inside and at an angle to the threaded inner surface;
a geometric shape surface positioned proximate to the bottom, and the bottom end surface extending between the threaded inner surface and the geometric shape surface, and the bottom end surface being annular in shape and extending about the geometric shape surface; and
the geometric shape surface constituting a first part of a second sealing device; and
a second male connector that is received into the female port in a sealing manner to provide a second assembly that provides a second connection;
and
the female port for receiving, in a sealing manner, a first male connector to provide a first assembly, to provide a first connection and for enabling a flow of gas through the first connection, and
the first male connector including a second part of the first sealing device; and
the geometric shape surface (a) engaged with a compatible male metal geometric shape, situated at a distal end of the second male connector and (b) providing a metal-on-metal seal by contact of the geometric shape surface of the female port against the male metal geometric shape of the second male connector, and the male metal geometric shape providing a second part of the second sealing device;
the second male connector including a threaded outer surface of the second male connector;
the second male connector including an annular end surface that extends between the male metal geometric shape and the threaded outer surface of the second male connector, and
the female port is suitable to receive, as an alternative to the second male connector, the first male connector so as to constitute the second assembly, and
the first male connector and the second male connector being different types of connectors, and
the first part of the first sealing device being the bearing surface for squeezing, when the first male connector is screwed into the female port, the second part of the first sealing device of the first male connector, and
the second part of the first sealing device including a seal; and
wherein construct of the female port, the first male connector and the second male connector is such that:
the bearing surface (a) is engageable with the second part of the first sealing device in the first assembly, and (b) is not in contact with the second male connector in the second assembly;
the threaded inner surface (a) is adapted to engage with a threaded outer surface of the first male connector in the first assembly, and (b) is engaged with the threaded outer surface of the second male connector in the second assembly;
the bottom end surface (a) is adapted to engage with an end of the first male connecter, and in the first assembly, and (b) is not in contact with the second male connector in the second assembly; and
the geometric shape surface (a) is not engageable with the first male connector in the first assembly, and (b) is engaged with the male metal geometric shape of the second male connector in the second assembly.

2. The connector as claimed in claim 1, wherein:
the first sealing device provides a first type of seal between the female port and the first male connector;
the second sealing device provides a second type of seal between the female port and the second male connector; and
the first type of seal being different than the second type of seal in that the first type of seal is directed to different operating conditions.

3. The connector as claimed in claim 2, wherein the different operating conditions between the first and the second sealing devices are those determined by at least one condition linked at least one selected from the group consisting of pressure, temperature, chemical attack and vibrations.

4. The connector as claimed in claim 1, wherein the thread of the female port includes a female thread, and
the female thread is suitable for receiving respective threads of the first male connector and the second male connector; and
the female thread having same thread pitch and diameter as each of the first male connector and the second male connector.

5. The connector as claimed in claim 1, wherein:
the second male connector includes a pipe; and
the male metal geometric shape is provided at a distal end of the pipe, the pipe passes through an interior of the second male connector and gas can flow through the pipe, and the pipe being locked in the interior of the second male connector.

6. The connector as claimed in claim 1, wherein the male metal geometric shape forms part of a pipe anchoring device, which passes through an interior of the second male connector and through which gas can flow, at the distal end of the second male connector.

7. The connector as claimed in claim 1, wherein the male metal geometric shape, of the second male connector, and the geometric shape surface of the female port are conical surfaces.

8. The connector as claimed in claim 1, wherein the female port is adapted to receive the first male connector in a sealing manner so as to provide for the circulation of gas through the connection, and the gas is hydrogen gas.

9. The connector as claimed in claim 2, wherein the thread of the female port includes a female thread, and
the female thread is suitable for receiving respective threads of the first male connector and the second male connector; and
the female thread having same thread pitch and diameter as each of the first male connector and the second male connector.

10. The connector as claimed in claim 3, wherein the thread of the female port includes a female thread, and
the female thread is suitable for receiving respective threads of the first male connector and the second male connector; and
the female thread having same thread pitch and diameter as each of the first male connector and the second male connector.

11. The connector as claimed in claim 2, wherein:
the second male connector includes a pipe; and
the male metal geometric shape is provided at a distal end of the pipe, the pipe passes through an interior of the second male connector and gas can flow through the pipe, and the pipe being locked in the interior of the second male connector.

12. The connector as claimed in claim 3, wherein:
the second male connector includes a pipe; and
the male metal geometric shape is provided at a distal end of the pipe, the pipe passes through an interior of the second male connector and gas can flow through the pipe, and the pipe being locked in the interior of the second male connector.

13. The connector as claimed in claim 4, wherein:
the second male connector includes a pipe; and
the male metal geometric shape is provided at a distal end of the pipe, the pipe passes through an interior of the second male connector and gas can flow through the pipe, and the pipe being locked in the interior of the second male connector.

14. The connector as claimed in claim 2, wherein the male metal geometric shape forms part of a pipe anchoring device, which passes through an interior of the second male connector and through which gas can flow, at the distal end of the second male connector.

15. The connector as claimed in claim 3, wherein the male metal geometric shape forms part of a pipe anchoring device, which passes through an interior of the second male connector and through which gas can flow, at the distal end of the second male connector.

16. The connector as claimed in claim 4, wherein the male metal geometric shape forms part of a pipe anchoring device, which passes through an interior of the second male connector and through which gas can flow, at the distal end of the second male connector.

17. The connector as claimed in claim 2, wherein the male metal geometric shape and the geometric shape surface of the female port are conical surfaces;
the threaded inner surface of the female port is of uniform diameter along a length of the female port; and
the bottom end surface is annular on a plane extending about an end of the threaded inner surface.

18. The connector as claimed in claim 3, wherein the male metal geometric shape and the geometric shape surface of the female port are conical surfaces.

19. The connector as claimed in claim 4, wherein the male metal geometric shape and the geometric shape surface of the female port are conical surfaces.

20. The connector as claimed in claim 5, wherein the male metal geometric shape and the geometric shape surface of the female port are conical surfaces.
